(19) United States
(12) Patent Application Publication
(10) Pub. No.: US 2018/0092092 A1
(43) Pub. Date: Mar. 29, 2018

(54) SUBBAND MEDIA ACCESS CONTROL PROTOCOL DATA UNIT AGGREGATION

(71) Applicant: Intel IP Corporation, Santa Clara, CA (US)

(72) Inventors: LAURENT CARIOU, PORTLAND, OR (US); CARLOS CORDEIRO, PORTLAND, OR (US)

(21) Appl. No.: 15/277,673

(22) Filed: Sep. 27, 2016

(51) Int. Cl. H04W 72/04; H04B 7/04; H04L 27/26; H04L 1/00; H04L 29/06; H04L 29/08

(52) U.S. Cl. CPC H04W 72/0453; H04B 7/0452; H04L 27/2601; H04W 84/12; H04L 69/22; H04L 69/323; H04L 1/0009

(57) ABSTRACT

This disclosure describes systems, methods, and devices related to subband media access control protocol data unit (MPDU) aggregation. A device may determine a first subband and a second subband of a frequency band associated with a communication channel with a first device. The device may allocate a first MPDU to the first subband. The device may allocate a second MPDU to the second subband. The device may cause the first MPDU to be wirelessly transmitted to the first device over the communication channel using a first modulation and coding scheme (MCS) value associated with the first subband. The device may cause the second MPDU to be wirelessly transmitted to the first device over the communication channel using a second MCS value associated with the second subband.

### TECHNICAL FIELD

This disclosure generally relates to systems and methods for wireless communications and, more particularly, to media access control protocol data unit (MPDU) aggregation.

### BACKGROUND

Wireless devices are becoming widely prevalent and are increasingly requesting access to wireless channels. A wireless communication network in a millimeter-wave band may provide high-speed data access for users of wireless communication devices. Beamforming represents techniques that can be used for enhancing throughput and range in wireless networks including, but not limited to, the next generation 60 GHz (NG60) network.

### BRIEF DESCRIPTION OF THE DRAWINGS

FIG. 1A depicts a network diagram illustrating an example network environment for subband media access control protocol data unit (MPDU) aggregation, in accordance with one or more example embodiments of the present disclosure.

FIGS. 1B-1C depict illustrative schematic diagrams of channel transfer functions of wideband orthogonal frequency division multiplex (OFDM) and subband modulation and coding scheme (MCS) selection, in accordance with one or more example embodiments of the present disclosure.

FIGS. 2 depicts an illustrative schematic diagram of a transmitting device's physical layer (PHY) chain modifications to enable MPDU aggregation per subband, in accordance with one or more example embodiments of the present disclosure.

FIGS. 3A-3B depict illustrative schematic diagrams of block acknowledgement for MPDU aggregation per subband, in accordance with one or more example embodiments of the present disclosure.

FIGS. 4A-4B depict illustrative schematic diagrams of subband MPDU aggregation, in accordance with one or more example embodiments of the present disclosure.

FIG. 5A depicts a flow diagram of an illustrative process for subband MPDU aggregation, in accordance with one or more example embodiments of the present disclosure.

FIG. 5B depicts a flow diagram of an illustrative process for subband MPDU aggregation, in accordance with one or more example embodiments of the present disclosure.

FIG. 6 illustrates a functional diagram of an example communication station that may be suitable for use as a user device, in accordance with one or more example embodiments of the present disclosure.

FIG. 7 is a block diagram of an example machine upon which any of one or more techniques (e.g., methods) may be performed, in accordance with one or more example embodiments of the present disclosure.

### DETAILED DESCRIPTION

Example embodiments described herein provide certain systems, methods, and devices for subband MPDU aggregation.

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Devices may communicate with each other by sending and receiving one or more frames between each other. These frames may include one or more fields (or symbols) that may be based on IEEE 802.11 specifications, including, but not limited to, an IEEE 802.11ad specification or an IEEE 802.11ay specification. In some IEEE 802.11 specifications, devices may operate in accordance with multiuser (MU) multiple-input and multiple-output (MIMO) technology. MIMO facilitates multiplying the capacity of a radio link using multiple transmit and receive antennas to exploit multipath propagation. MIMO provides a practical technique for sending and receiving more than one data signal on the same radio channel at the same time via multipath propagation. MU-MIMO provides a way for wireless devices to communicate with each other using multiple antennas such that the wireless devices may transmit at the same time and frequency and still be separated by their spatial signatures. For example, using MU-MIMO, an access point (AP) may be able to communicate with multiple devices using multiple antennas at the same time to send and receive data. An AP operating in MU-MIMO and in a 60 GHz frequency band may utilize an MU-MIMO frame to communicate with devices serviced by that AP.

Typically, during wideband orthogonal frequency division multiplex (OFDM) transmissions, a particular modulation and coding scheme (MCS) value is used on the entire frequency band. For example, an AP may determine a particular MCS value to be used while communicating with a user device (also referred to as a station device (STA)). A frequency band may consist of one or more frequency subbands. In that scenario, no MCS adaptation is employed between the various frequency subbands.

Currently, no frequency selective channels adaptive bit loading is defined or proposed for 60 GHz.

Example embodiments of the present disclosure relate to systems, methods, and devices for subband MPDU aggregation.

In some demonstrative embodiments, one or more devices may be configured to communicate an MU-MIMO frame, for example, over a 60 GHz frequency band. The one or more devices may be configured to communicate in a mixed environment such that one or more legacy devices are able to communicate with one or more non-legacy devices. That is, devices following one or more IEEE 802.11 specifications may communicate with each other regardless of which IEEE 802.11 specification is followed.

Directional multi-gigabyte (DMG) communications may involve one or more directional links to communicate at a rate of multiple gigabits per second, for example, at least 1 gigabit per second, 7 gigabits per second, or any other rate. An amendment to a DMG operation in a 60 GHz band, e.g., according to an IEEE 802.11ad standard, may be defined, for example, by an IEEE 802.11y project.

In some demonstrative embodiments, one or more devices may be configured to communicate over a next generation 60 GHz (NG60) network, an extended DMG (EDMG) network, and/or any other network. For example, the one or more devices may be configured to communicate over the NG60 or EDMG networks.

In one embodiment, an unsynchronized MU-MIMO system may enable directionality of one or more antennas. That is, a transmission link between an antenna from the AP and one STA may be established independently with respect to another link from another antenna from the AP and another STA. This may enable the AP to perform scheduling and interference coordination between one or more STAs using different sectors associated with the one or more antennas.

Various modulation schemes and coding rates may be defined by a wireless standard, which may be represented by a modulation and coding scheme (MCS) index value. MCS index values may be used to determine the likely data rate of a Wi-Fi connection during a wireless communication between two devices (e.g., between an AP and a user device). The MCS value essentially determines the modulation type (e.g., BPSK, QPSK, 16-QAM, 64-QAM), and the coding rate (e.g., ½, ⅔, ¾, ⅚) that is possible when connecting to an access point, where BPSK stands for binary phase shift keying, QPSK stands for quadrature phase shift keying, and QAM stands for quadrature amplitude modulation). It is understood that modulation is the method by which data is communicated through the air. The more complex the modulation, the higher the data rate. Modulations that are more complex may require better conditions such as less interference and a good line of sight. The coding rate may be an indication of how much of a data stream is actually being used to transmit usable data. This may be expressed as a fraction with the most efficient rate being ⅚ or 83.3% of the data stream being used. The actual MCS may depend on variables such as hardware design and local interferences that may affect the rate and the network performance during the communication. For example, if a wireless or Wi-Fi connection cannot be maintained when there are too many errors being experienced during the communication between the two devices, the MCS value may be lowered by selecting a different modulation type and/or coding rate in order to reduce the error rate. Although the MCS may indicate the data rate of the wireless or Wi-Fi connection, it may not determine the actual throughput of the network.

In one embodiment, a subband MPDU aggregation system may separate the frequency domain into one or more subbands, and may allocate one or more MPDUs that may be associated with each subband.

In one embodiment, the one or more MPDUs transmitted on a particular subband may go through a specific part of a physical layer (PHY) chain. Doing so may facilitate the selection of a specific MCS associated with the particular subband.

In one embodiment, an MCS field in a header-A of PHY headers or preambles may be modified to indicate all of the subbands' MCSs. For example, an MCS field may indicate a specific subband. In another embodiment, an average MCS value may be used and a differential MCS index adjustment per subband may be made in order to reduce the size of the fields. In another embodiment, an index may be utilized to indicate a specific MCS value that is used for each subband. In yet another embodiment, the header-B may be used by transmitting different header-Bs on each subband. In that case, the MCS indication should be transferred to header-B, and the MCS in header-B in a particular subband corresponds to that subband only.

In one embodiment, the subband MPDU aggregation system may enable link adaptation at a transmitting device. That is, the subband MPDU aggregation system may adapt links between a transmitting device (e.g., an AP) and a receiving device (e.g., an STA) based on one or more conditions. For example, in one condition, the transmitting device may analyze the probability of reception of the MPDUs assigned to a particular subband, by looking at the block acknowledgments (BAs). That is, the transmitting device may determine whether the MPDUs assigned to a particular subband have been received by the receiving device based on looking at a BA received from a receiving device. This may allow the use of a simple link adaptation mechanism based only on link adaptation statistics. The link adaptation statistics may be based on BA reception. For example, a transmitting device may send packets with a specific MCS value to the receiving device. The transmitting device may then receive a BA from the receiving device indicating that the packets have been received. The transmitting device may record the statistics over a certain time. For example, for each selected MCS value, the transmitting device may determine the proportion of packets that were successfully received, and based on that, the transmitting device may select the next MCS value in the next subband.

Another condition may be to perform signal-to-noise ratio (SNR) and quality indicator measurements per subband or MCS recommendations per subband that are fed back from the receiving device to the transmitting device. This may facilitate a quick convergence toward the appropriate selection of MCS values per subband at the transmitting device.

In one embodiment, the subband MPDU aggregation system may determine if the BAs are sent per subband (e.g., whether a BA is sent on one subband). In that case, the statistics from the BA may relate to that subband and may be used for the link adaptation mechanism from that subband directly.

In one embodiment, the subband MPDU aggregation system may determine if a single BA is sent for all subbands. That is, the device that receives the BA may filter the bitmap of the BA in order to regroup only the sequence numbers (SNs) corresponding to MPDUs transmitted on the same subband and to use these sequence numbers for per subband link adaptation. The BA bitmap is used to indicate the received status of the MPDUs. Bit position n of the BA bitmap, if equal to 1, acknowledges receipt of an MPDU with an MPDU sequence control value equal to (SSC+n), where SSC is the value of the BA starting sequence control subfield. Bit position n of the BA bitmap, if equal to 0, indicates that an MPDU with an MPDU sequence control value equal to (SSC+n) has not been received.

The above descriptions are for purposes of illustration and are not meant to be limiting. Numerous other examples, configurations, processes, etc., may exist, some of which are described in greater detail below. Example embodiments will now be described with reference to the accompanying figures.

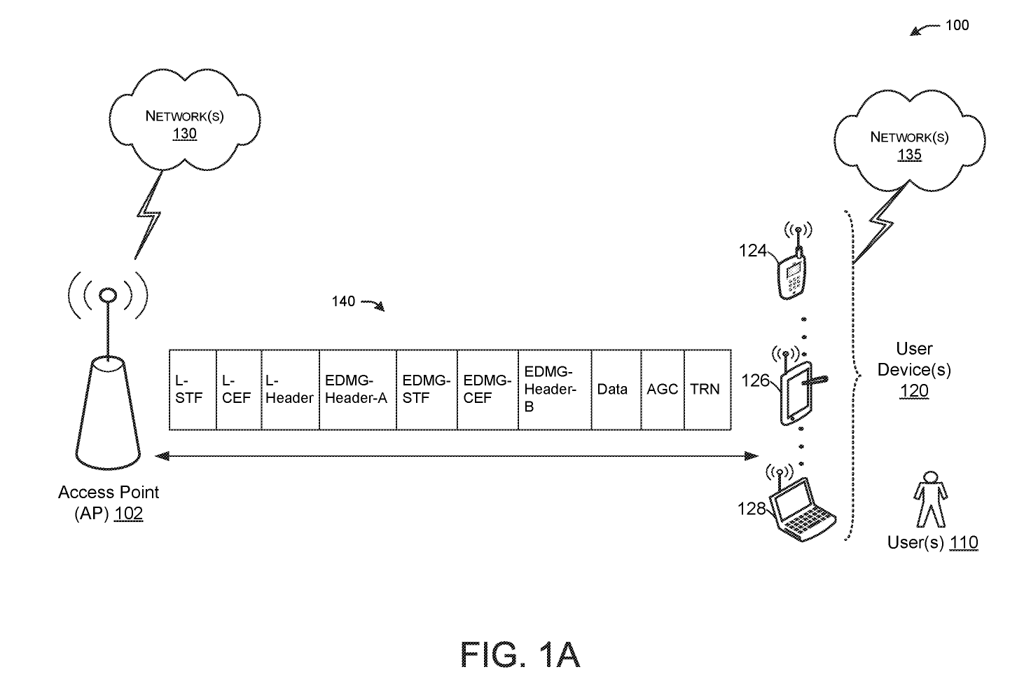

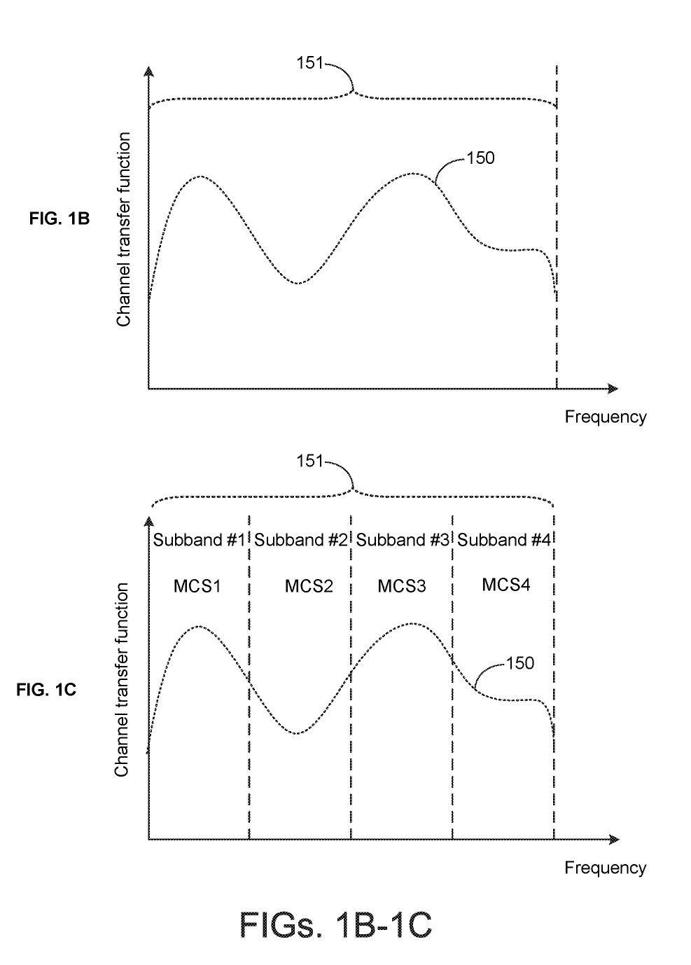

FIG. 1A is a network diagram illustrating an example network environment for subband MPDU aggregation, according to some example embodiments of the present disclosure. Wireless network 100 may include one or more user device(s) 120 and one or more access point(s) (AP) 102, which may communicate in accordance with IEEE 802.11 communication standards, such as the IEEE 802.11ad and/or IEEE 802.11ay specifications. The user device(s) 120 may be mobile devices that are non-stationary and do not have fixed locations.

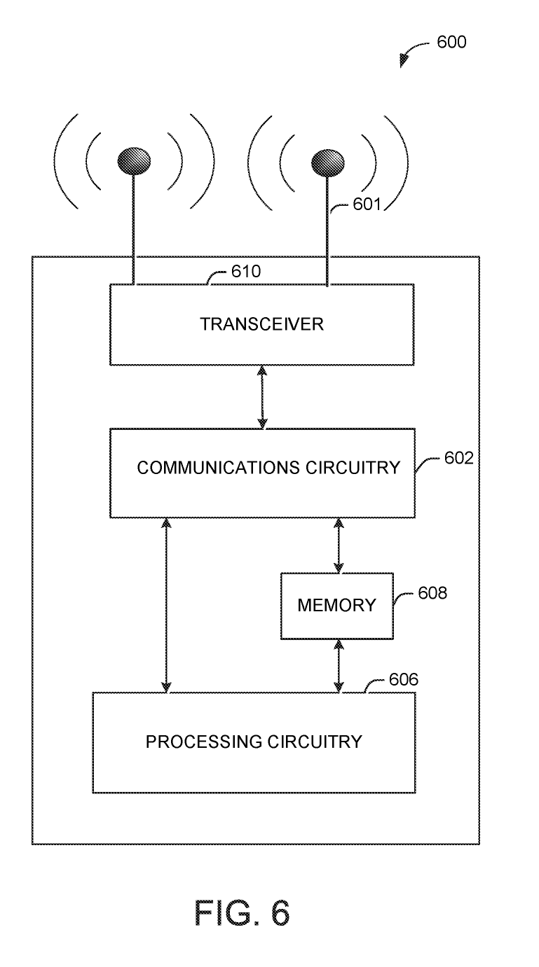

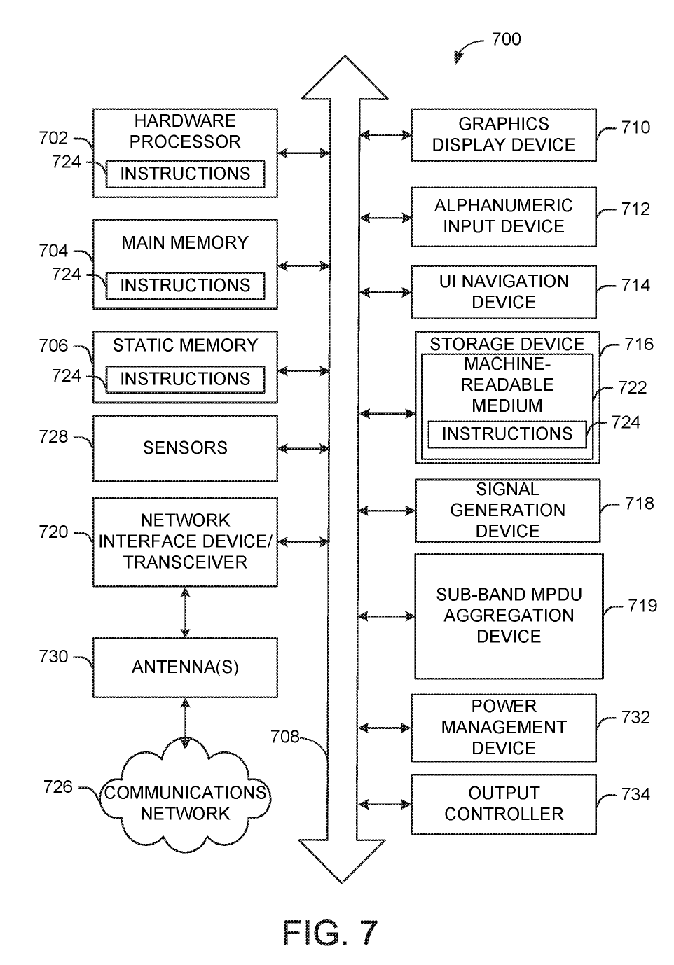

In some embodiments, the user device(s) 120 and the AP 102 may include one or more computer systems similar to that of the functional diagram of FIG. 6 and/or the example machine/system of FIG. 7.

One or more illustrative user device(s) 120 and/or the AP 102 may be operable by one or more user(s) 110. The user device(s) 120 (e.g., 124, 126, or 128) and/or the AP 102 may include any suitable processor-driven device including, but not limited to, a mobile device or a non-mobile, e.g., a static, device. For example, the user device(s) 120 and/or the AP 102 may include a user equipment (UE), a station (STA), an access point, a personal basic service set (PBSS) control point, a personal computer (PC), a wearable wireless device (e.g., bracelet, watch, glasses, ring, etc.), a desktop computer, a mobile computer, a laptop computer, an ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like.

Any of the user device(s) 120 (e.g., user devices 124, 126, 128), and the AP 102 may be configured to communicate with each other via one or more communications networks 130 and/or 135 wirelessly or wired. Any of the communications networks 130 and/or 135 may include, but are not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof

Any of the user device(s) 120 (e.g., user devices 124, 126, 128), and the AP 102 may include one or more communications antennas 140. The one or more communications antennas 140 may be any suitable type of antennas corresponding to the communications protocols used by the user device(s) 120 (e.g., user devices 124, 126 and 128), and the AP 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or the AP 102.

Any of the user device(s) 120 (e.g., user devices 124, 126, 128), and the AP 102 may be configured to perform directional transmission and/or directional reception in conjunction with wirelessly communicating in a wireless network. Any of the user device(s) 120 (e.g., user devices 124, 126, 128), and the AP 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and the AP 102 may be configured to perform any given directional transmission towards one or more defined transmit sectors. Any of the user device(s) 120 (e.g., user devices 124, 126, 128), and the AP 102 may be configured to perform any given directional reception from one or more defined receive sectors.

MIMO beamforming in a wireless network may be accomplished using RF beamforming and/or digital beamforming. In some embodiments, in performing a given MIMO transmission, the user devices 120 and/or the AP 102 may be configured to use all or a subset of its one or more communications antennas to perform MIMO beamforming.

Any of the user devices 120 (e.g., user devices 124, 126, 128), and the AP 102 may include any suitable radio and/or transceiver for transmitting and/or receiving radio frequency (RF) signals in the bandwidth and/or channels corresponding to the communications protocols utilized by any of the user device(s) 120 and the AP 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g., 802.11b, 802.11g, 802.11n, 802.11ax), 5 GHz channels (e.g., 802.11n, 802.11ac, 802.11ax), or 60 GHz channels (e.g., 802.11ad). In some embodiments, non-Wi-Fi protocols may be used for communications between devices, such as Bluetooth, dedicated short-range communication (DSRC), ultra-high frequency (UHF) (e.g., IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and a digital baseband.

Some demonstrative embodiments may be used in conjunction with a wireless communication network communicating over a frequency band of 60 GHz. However, other embodiments may be implemented utilizing any other suitable wireless communication frequency bands, for example, an extremely high frequency (EHF) band (the millimeter wave (mmWave) frequency band), a frequency band within the frequency band of between 20 GHz and 300 GHz, a WLAN frequency band, a WPAN frequency band, a frequency band according to the WGA specification, and the like.

An antenna for a radio transmitter converts signals into electromagnetic waves to be transmitted to a receiving device. Any antenna that transmits can also receive. A transmitting antenna may generate stronger electromagnetic waves in some directions than other antennas. The antenna may radiate waves of a different amplitude and phase, and each of these waves travels a different distance to the point where a receiving device is located. In some directions, these waves add constructively to give a gain. In some directions, these waves cause interference and a loss of gain. An omnidirectional antenna may be an antenna that has a non-directional pattern (circular pattern) in a given plane with a directional pattern in any orthogonal plane. An omnidirectional antenna may have a wider angle to allow communication with multiple devices.

In communications, beamforming is used to point an antenna at the signal source to reduce interference and improve communication quality. In direction finding applications, beamforming can be used to steer an antenna to determine the direction of the signal source.

The phrases “directional multi-gigabit (DMG)” and “directional band (DBand),” as used herein, may relate to a frequency band wherein the channel starting frequency is above 45 GHz. In one example, DMG communications may involve one or more directional links to communicate at a rate of multiple gigabits per second, for example, at least 1 gigabit per second, 7 gigabits per second, or any other rate.

In some demonstrative embodiments, the user device(s) 120 and/or the AP 102 may be configured to operate in accordance with one or more specifications, including one or more IEEE 802.11 specifications (e.g., an IEEE 802.11ad specification, an IEEE 802.11ay specification, and/or any other specification and/or protocol). For example, an amendment to a DMG operation in the 60 GHz band, according to an IEEE 802.11ad standard, may be defined, for example, by an IEEE 802.11ay project.

In some demonstrative embodiments, the user device(s) 120 and/or the AP 102 may be configured to implement one or more multi-user (MU) mechanisms. For example, the user device(s) 120 and/or the AP 102 may be configured to implement one or more MU mechanisms, which may be configured to enable MU communication of downlink (DL) frames using a multiple-input and multiple-output (MIMO) scheme between a device (e.g., AP 102) and a plurality of user devices, including the user device(s) 120 and/or one or more other devices.

In some demonstrative embodiments, the user devices 120 and/or the AP 102 may be configured to communicate over a next generation 60 GHz (NG60) network, an extended DMG (EDMG) network, and/or any other network. For example, the user devices 120 and/or the AP 102 may be configured to communicate MIMO transmissions (e.g., DL MU-MIMO) and/or use channel bonding for communicating over the NG60 and/or EDMG networks.

In some demonstrative embodiments, the user devices 120 and/or the AP 102 may be configured to support one or more mechanisms and/or features (e.g., channel bonding, single user (SU) MIMO, and/or multiuser (MU) MIMO) in accordance with an EDMG standard, an IEEE 802.11ay standard, and/or any other standard and/or protocol.

In order for an AP (e.g., AP 102) to establish communication with one or more user device(s) 120 (e.g., user devices 124, 126, and/or 128), the AP 102 may communicate in a downlink direction, and the user device(s) 120 may communicate with the AP 102 in an uplink direction by sending frames in either direction. The frames may include one or more training fields that may be used for channel estimation, channel training, channel characterization, and other functions needed for establishing a channel between a transmitting device, such as an AP 102, and a receiving device, such as a user device 120.

Beamforming of beams on an antenna may utilize training fields in order to enhance the formation of beams. These training fields may be communicated between devices (e.g., the AP 102 and/or the user device(s)s 120). Beamforming depends on channel calibration procedures, called channel sounding, to determine how to radiate energy in a preferred direction. Many factors may influence how to steer a beam in a particular direction. Beamforming enables the endpoints at either side of a link to get maximum performance by taking advantage of channels that have strong performance while avoiding paths and carriers that have weak performance.

In one embodiment, and with reference to FIG. 1, a device (e.g., the user device(s) 120 and/or the AP 102) may be configured to communicate an MU-MIMO frame, for example, over a 60 GHz frequency band.

Referring to FIG. 1, there is shown a PHY header 140 (which may also be an EDMG header). The PHY header 140 may include, at least in part, a legacy short training field (L-STF), a legacy channel estimation field (L-CEF), a legacy header (L-header), an EDMG-header-A, an EDMG-STF, an EDMG-CEF, and an EDMG-header-B. The PHY header 140 may also include data, an optional automatic gain control (AGC) field, and beamforming training units (TRNs). It is understood that the above acronyms may be different and should not be construed as a limitation because other acronyms may be used for the fields included in a PHY header 140. The AP 102 and the user devices 120 may communicate with each other by sending and receiving a PHY header (e.g., PHY header 140). The PHY header 140 may include MCS information that may facilitate the MCS selection per subchannel. For example, an MCS field in the header-A of PHY header 140 may be modified to indicate all of the subbands' MCSs. For example, an MCS field may indicate a specific subband (e.g., MCS1 may be associated with a subband1). In another example, an average MCS value may be used and a differential MCS index adjustment per subband may be made in order to reduce the size of the fields. In another example, an index may be utilized to indicate a specific MCS value that is used for each subband. In yet another example, the header-B may be used by transmitting different header-Bs on each subband. In that case, the MCS indication may be transferred to header-B, and the MCS in header-B in a particular subband corresponds to that subband only. It is understood that the above descriptions are for purposes of illustration and are not meant to be limiting.

FIGS. 1B-1C depict illustrative schematic diagrams of channel transfer functions of wideband OFDM and subband MCS selection, in accordance with one or more example embodiments of the present disclosure.

Referring to FIG. 1B, there is shown a channel transfer function in a frequency domain of a wideband OFDM. A channel transfer function 150 is the norm of the channel response on a particular OFDM subcarrier. Based on the norm of the channel response per subcarrier, the average channel response over the entire frequency band 151 may be calculated. Further, the entire frequency band 151 may be associated with the maximum MCS value that can be used for that entire frequency band 151. In that case, a frequency band 151 selects an MCS value that may be used on the entire frequency band.

Referring to FIG. 1C, there is shown one or more MCS values that may be selected on a per subband basis. In this figure, the frequency band may be divided into four subbands (e.g., subband #1, subband #2, subband #3, and subband #4). In that case, instead of utilizing a single MCS value for the entirety of the frequency band 151—including the four subbands—a subband MPDU aggregation system may select a specific MCS (e.g., MCS1, MCS2, MCS3, and MCS4) for each of the four subbands. That is, when dividing the frequency band into subbands, the MCS is selected per subband. For example, subband #1 may be associated with MCS1, subband #2 may be associated with MCS2, subband #3 may be associated with MCS3, and subband #4 may be associated with MCS4. Having frequency selective channel adaptive bit loading (frequency selective MCS selection) may provide enhanced throughput compared to wideb and OFDM. Simulation results comparing wideband OFDM having the same MCS used on the whole band with specific MCS selection done per subband demonstrated about 20% gains in throughput.

In one embodiment, aggregating different MPDUs in different subbands may achieve specific MCS selection per subband.

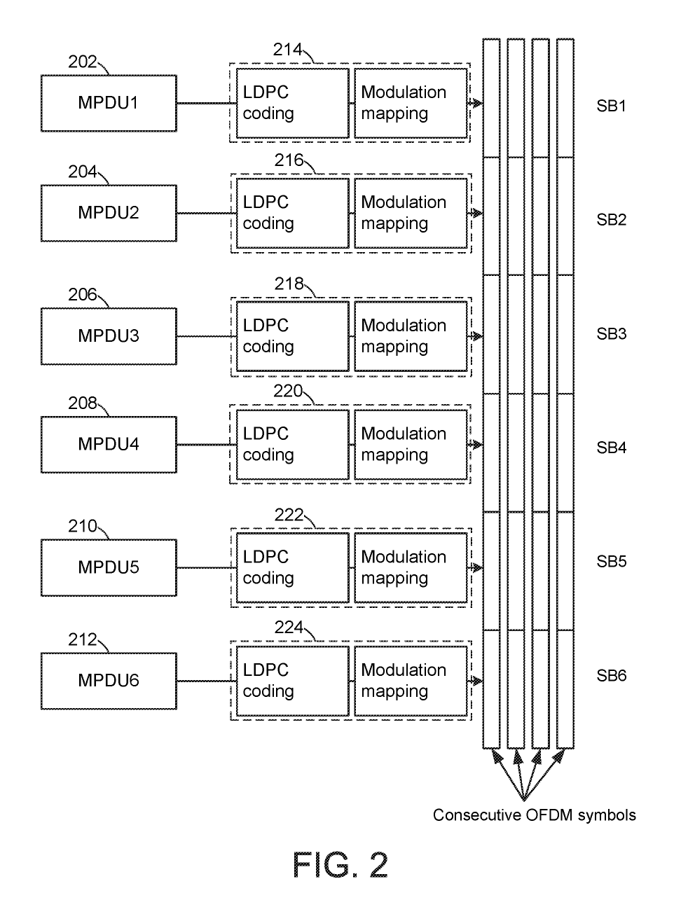

FIG. 2 depicts an illustrative schematic diagram of a transmitting device's PHY chain modifications to enable MPDU aggregation per subband, in accordance with one or more example embodiments of the present disclosure.

As shown in FIG. 2, a transmitting device (e.g., the user devices 120 and/or the AP 102 of FIG. 1A) may determine a number of subbands that a number of MPDUs may be transmitted on. In this example, six subbands (e.g., SB1-SB6) and six MPDUs (e.g., MPDUs 202-212) are depicted as having separate PHY chains for low-density parity check (LDPC) coding and modulation mapping. Basically, the PHY chain is duplicated on each subband, and the different MPDUs are oriented toward different subband PHY chains. The processing rate of each subband PHY may be reduced proportionally to the number of subbands without increasing complexity. In each PHY chain of a subband, there may be a specific LDPC coding, and a specific modulation mapping (e.g., blocks 214-224). The code rate and the modulation mapping applied on a particular subband may be selected by the transmitting device based on a subband link adaptation mechanism. An example of subband link adaptation mechanism may be based on looking at the BA received from the receiving device. This may allow the use of a simple link adaptation mechanism based only on link adaptation statistics. The link adaptation statistics may be based on the BA reception. For example, a transmitting device may send packets with a specific MCS value to the receiving device. The transmitting device may then receive a BA from the receiving device indicating that the packets have been received. The transmitting device may record the statistics over a certain time. For example, for each selected MCS value, the transmitting device may determine the proportion of packets that were successfully received, and based on that, the transmitting device may select the next MCS value in the next subband.

In a simplistic example, if the transmitting device sends 10 packets with an MCS value of 1 in a first subband, and if the transmitting devices determine, based on the received BAs associated with the 10 packets, that all of these packets were received, the transmitting device may select a new MCS value of 2 in a second subband, and so on. If at one point the transmitting device determines that only a proportion of the packets were received by the receiving device based on the BAs, the transmitting device may fall back to a previous MCS value in a third subband.

At the output of the modulation mapping, the symbols may be mapped to a vector representing the different subcarriers of the OFDM modulation at the sub-carrier locations corresponding to the subband. A single vector gathers all symbols from each subband PHY chain that will be transmitted in one OFDM symbol. The OFDM modulation and guard interval addition is then applied to this vector.

Similarly, the receiving device may split the OFDM symbol after OFDM demodulation in the PHY processing per subband on the receiving device. The PHY processing may apply the correct detection with the correct modulation and code rate. The received MPDUs are then reordered if needed and transmitted to the MAC layer on the receiving device to generate the BA for transmission in the reverse direction to the transmitting device. It is understood that the above descriptions are for purposes of illustration and are not meant to be limiting.

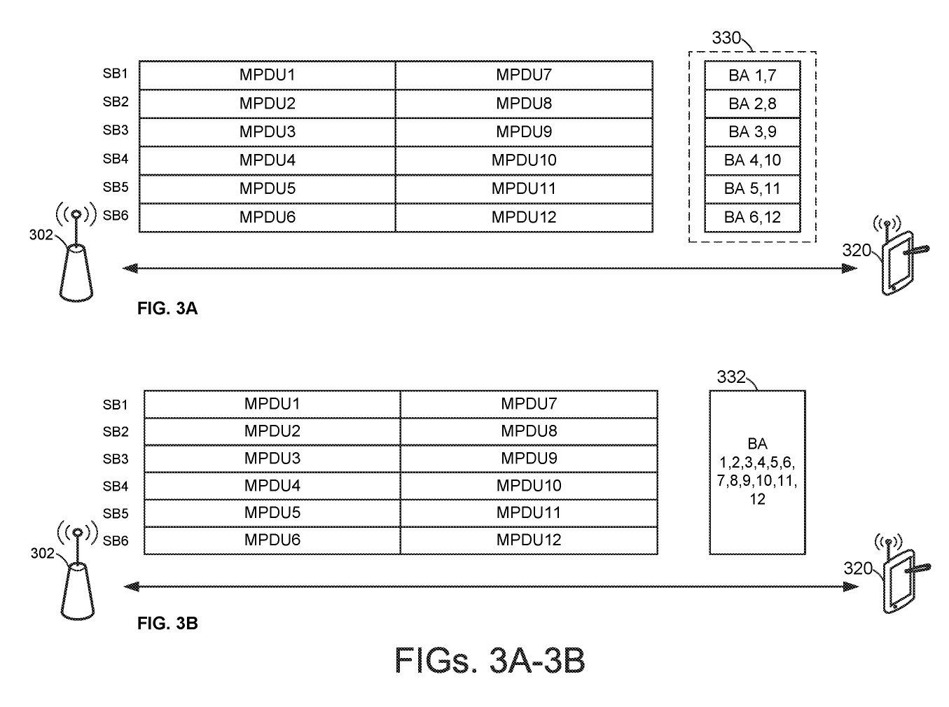

FIGS. 3A-3B depict illustrative schematic diagrams of block acknowledgement for MPDU aggregation per subband, in accordance with one or more example embodiments of the present disclosure.

A transmitting device (e.g., an AP) may send packets using a specific MCS value to a receiving device (e.g., a user device 120). The receiving device may then send a BA to the transmitting device. The transmitting device may receive the BA from the receiving device indicating that the packets have been received (or not). The receiving device may send the BA frame either per subband using the same subband transmission, as seen in FIG. 3A, or a single BA frame may be sent for all subbands, as seen in FIG. 3B.

Referring to FIG. 3A, there is shown a number of MPDUs that are sent consecutively from a transmitting device (e.g., AP 302) to a receiving device (e.g., user device 320). For example, the AP 302 may send using six subchannels (e.g., SB1-SB6) and two sets of MPDUs consecutively. In this example, MPDU1-MPDU6 are sent first to the user device 320, then followed by MPDU7-MPDU12 using the six subchannels. The user device 320 may receive one or more of these MPDUs and may respond back to the AP 302 using multiple BAs 330. The BAs 330 may include six BAs sent using six subchannels. In this example, the BA associated with subchannel, SB1 may be reporting, at least in part, the reception status of MPDU1 and MPDU7. The same is true for subchannels, SB2-SB6, where the corresponding BA received from the user device 320 is associated with the particular MPDUs sent on that subchannel. It is understood that the above descriptions are for purposes of illustration and are not meant to be limiting.

Referring to FIG. 3B, there is shown a number of MPDUs. For example, the AP 302 may send using six subchannels (e.g., SB1-SB6) and two sets of MPDUs consecutively. In this example, MPDU1-MPDU6 are sent first to the user device 320, then followed by MPDU7-MPDU12 using the six subchannels. The user device 320 may receive one or more of these MPDUs and may respond back to the AP 302 using a single BA frame (e.g., BA frame 332) sent on the whole OFDM band, as opposed to FIG. 3A, where multiple BAs were sent on the various subchannels. This BA frame 332 may acknowledge all of the MPDUs (e.g., MPDU1-MPDU12) transmitted on all subbands. The AP 302 receiving the BA may then filter the BA bitmap information with the MPDU sequence numbers that were transmitted on a particular subband, in order to know the probability of detection per subband. That is based on whether an MPDU was received by the user device 320. The AP 302 may adjust the MCS value for a particular subchannel based on what was extracted from the bitmap of the BA frame 332. For example, if a particular MCS value was used for subchannel SB1, and the BA frame 332 did not indicate that the user device 320 received the MPDUs (e.g., MPDU1 and MPDU7) sent on that subchannel, the AP 302 may select a different MCS value for the next transmissions on that subchannel SB1. The same is true for the other subchannels. It is understood that the above descriptions are for purposes of illustration and are not meant to be limiting.

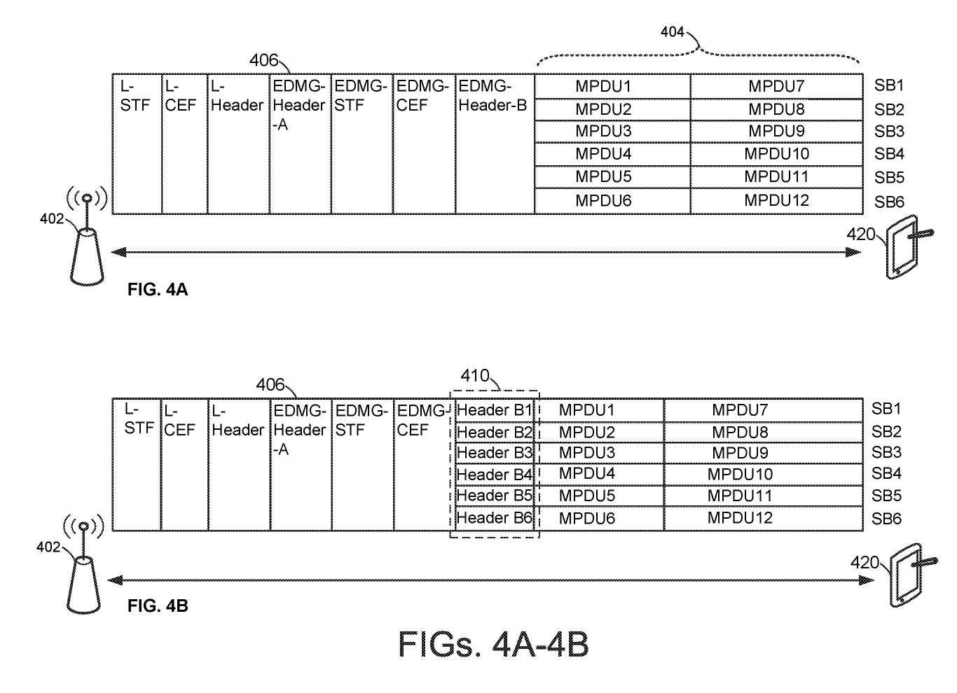

FIGS. 4A-4B depict illustrative schematic diagrams of subband MPDU aggregation, in accordance with one or more example embodiments of the present disclosure.

Referring to FIG. 4A, the AP 402 and the user device 420 may communicate with each other by sending and receiving a PHY header or preamble. For example, an EDMG PHY header may include, at least in part, an L-STF field, an L-CEF field, an L-header field, an EDMG-header-A field 406, an EDMG-STF field, an EDMG-CEF field, an EDMG-header-B field, and a data portion 404. In one embodiment, the EDMG PHY header may include MCS information that may facilitate the MCS selection per subchannel. For example, an MCS field in the EDMG-header-A field 406 of the PHY header may be modified to indicate all of the subbands' MCSs. A simple option is to have an MCS field for each subband. For example, MCS1 may be associated with SB1 and MCS2 may be associated with SB2 and so forth.

In another example, an average MCS value may be used and a differential MCS index adjustment per subband may be made in order to reduce the size of the fields. For example, an average MCS value may be equal to 6 and from there the various subbands may be adjusted accordingly. For example, subchannel SB1 may be associated with the MCS value 6 with an adjustment equal to −1 and SB2 may have an adjustment of +1. In that case, SB1 may be associated with the MCS value 5 and SB2 may be associated with the MCS value 7. The average MCS value may be calculated over the entire frequency band or on a per subband basis. The adjustment applied to the average MCS value may be determined based on the link adaptation.

In another example, all MCS combinations across subbands may also be associated with a specific index, which may be signaled in the header. For example, index 110100 may correspond to MCSS for SB1 and MCS7 to SB2.

Referring to FIG. 4B, in order to save overhead in the EDMG header-A 406, a subband MPDU aggregation system may use header-B fields 410. In that case, the subband MPDU aggregation system may facilitate the transmission of a number of header-B fields on each subband. Accordingly, the MCS indication may be transferred to header-B, where the MCS value in each header-B in a particular subband may correspond to that subband. For example, in header-B1, MCS1 may be associated with SB1, in header-B2, MCS2 may be associated with SB2, in header-B3, MCS3 may be associated with SB3, in header-B4, MCS4 may be associated with SB4, in header-B5, MCS5 may be associated with SB5, and in header-B6, MCS6 may be associated with SB6. The various header-B fields 410 may be the same or may be different. It is understood that the above descriptions are for purposes of illustration and are not meant to be limiting.

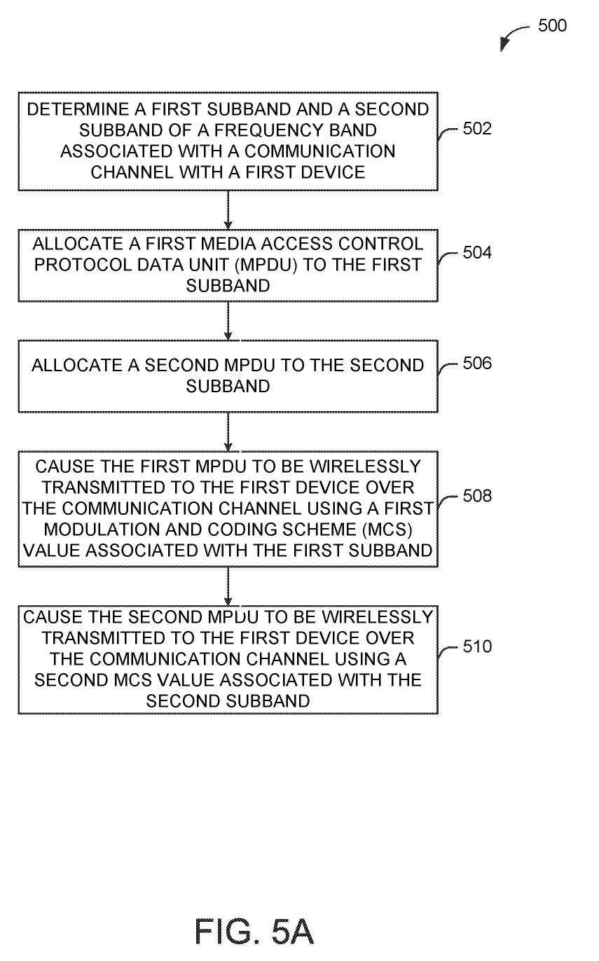

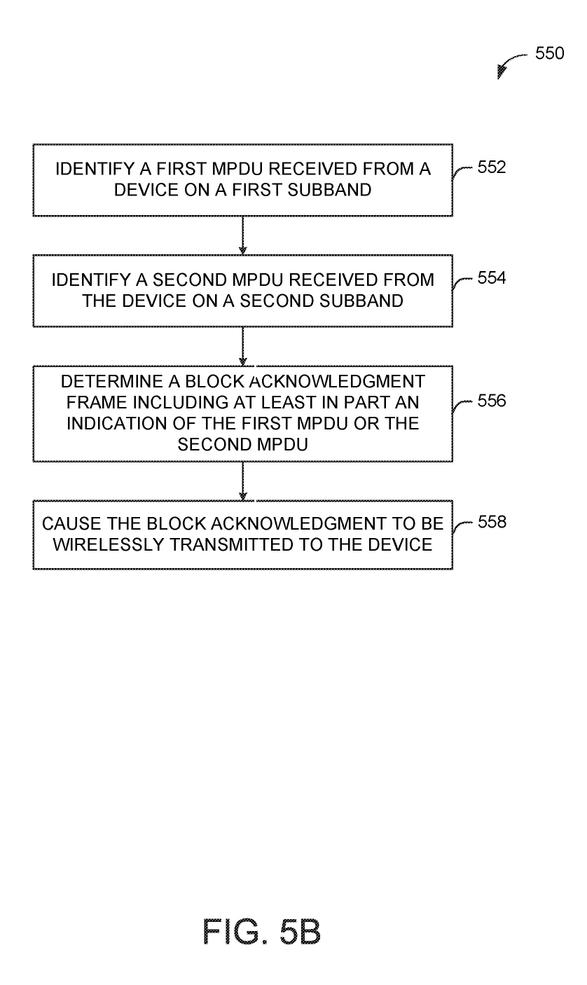

FIG. 5A illustrates a flow diagram of an illustrative process 500 for subband MPDU aggregation, in accordance with one or more example embodiments of the present disclosure.

At block 502, a device (e.g., the user device(s) 120 and/or the AP 102 of FIG. 1A) may determine a first subband and a second subband of a frequency band associated with a communication channel with a first device (e.g., the user device(s) 120 and/or the AP 102 of FIG. 1A). For example, an AP may communicate with a user device on a communication channel having a particular frequency band. The AP may separate the frequency band into one or more subbands.

At block 504, the device may allocate a first MPDU to the first subband. For example, the first subband may be used to transmit user data using the one or more MPDUs, including the first MPDU. The one or more MPDUs transmitted on the first subband may go through a specific part of a PHY chain. The PHY chain may be duplicated on each subband, and the one or more MPDUs are oriented toward different subband PHY chains. The processing rate of each subband PHY may be reduced proportionally to the number of subbands without increasing complexity. In each PHY chain of a subband, there may be a specific LDPC coding and a specific modulation mapping. The code rate and the modulation mapping applied on a particular subband may be selected by the transmitting device based on a subband link adaptation mechanism.

At block 506, the device may allocate a second MPDU to the second subband. Similar to the first subband, the second subband may be used to transmit user data using the one or more MPDUs. In addition, the second MPDU may go through a specific PHY chain, which may be a different PHY chain from the first subband.

At block 508, the device may cause the first MPDU to be wirelessly transmitted to the first device over the communication channel using a first modulation and coding scheme (MCS) value associated with the first subband. The MCS applied on a particular subband may be selected by the transmitting device based on a subband link adaptation mechanism. An example of a subband link adaptation mechanism may be based on looking at the BA received from the user device. This may allow the use of a simple link adaptation mechanism based only on link adaptation statistics. The link adaptation statistics may be based on the BA reception. For example, the AP may send packets with a specific MCS value to the user device. The AP may then receive a BA from the user device indicating that the packets have been received. The AP may record the statistics over a certain time. For example, for each selected MCS value, the AP may determine the proportion of packets that were successfully received, and based on that, the AP may select the next MCS value in the next subband.

The subband link adaptation mechanism may also include performing SNR and quality indicator measurements per subband or MCS recommendations per subband that are fed back from the receiving device to the transmitting device. This may facilitate a quick convergence toward the appropriate selection of MCS values per subband at the transmitting device.

In the case of determining the BA reception, the AP may determine if the BAs are sent per subband. That is, whether a BA is sent on one subband. In that case, the statistics from the BA may relate to that subband and may be used for the link adaptation mechanism from that subband directly.

In the case where the user device sends a single BA for all subbands, that is, when the AP receives the BA, the AP may filter the bitmap of the BA in order to regroup only the sequence numbers corresponding to MPDUs transmitted on the same subband and to use these sequence numbers for per subband link adaptation. The BA bitmap is used to indicate the received status of the MPDUs.

At block 510, the device may cause the second MPDU to be wirelessly transmitted to the first device over the communication channel using a second MCS value associated with the second subband. Similar to the above, the second MPDU transmitted over the second subband may also be associated with a second MCS value that may be determined based on the subband link adaptation mechanism above. It is understood that the above descriptions are for purposes of illustration and are not meant to be limiting.

FIG. 5B illustrates a flow diagram of an illustrative process 550 for subband MPDU aggregation, in accordance with one or more example embodiments of the present disclosure.

At block 552, a device (e.g., the user device(s) 120 and/or the AP 102 of FIG. 1A) may identify a first MPDU received from another device (e.g., the user device(s) 120 and/or the AP 102 of FIG. 1A) on a first subband. For example, the AP may have sent multiple MPDUs over multiple subbands using a PHY header (or preamble), which may have been converted to an OFDM symbol. The OFDM symbol may be received by the user device. The user device may split the OFDM symbol after OFDM demodulation in the PHY processing per subband on the user device. The PHY processing may apply the correct detection with the correct modulation and code rate (e.g., MCS). The MCS information may be contained in one or more fields of the PHY header. For example, the user device may decode one of the header-A, or header-B fields received in the PHY header. In at least one of these fields, the AP may have encoded or otherwise included MCS information associated with the subband. For example, the first subband may have its own MCS value encoded or otherwise included in the header-A or header-B fields.

At block 554, the device may identify a second MPDU received from the device on a second subband. For example, the user device may identify the second MPDU sent by the AP on the second subband. Again, the user device may determine the MCS value associated with the second subband. The MCS value may have been encoded or otherwise included in the header-A or header-B fields of the PHY header received from the AP. In some scenarios, an MCS field in a header-A of PHY headers or preambles may be modified to indicate all of the subbands' MCSs. For example, an MCS field may indicate a specific subband. In another example, an average MCS value may be used and a differential MCS index adjustment per subband may be made in order to reduce the size of the fields. In another example, an index may be utilized to indicate a specific MCS value that is used for each subband. In yet another example, the header-B may be used by transmitting different header-Bs on each subband. In that case, the MCS indication should be transferred to header-B, and the MCS in header-B in a particular subband corresponds to that subband only.

At block 556, the device may determine a block acknowledgment frame including at least in part an indication of the first MPDU or the second MPDU. For example, the user device may generate a BA frame and send it to the AP.

At block 558, the device may cause the block acknowledgment to be wirelessly transmitted to the other device. The AP may perform link adaptation to adapt links between the AP and the user device based on one or more conditions. For example, in one condition, the transmitting device may analyze the probability of reception of the MPDUs assigned to a particular subband, by looking at the BAs. That is, the AP may determine whether the MPDUs assigned to a particular subband have been received by the user device based on looking at the BA received from the user device. This may allow the use of a simple link adaptation mechanism based only on link adaptation statistics. The link adaptation statistics may be based on the BA reception. For example, the AP may send packets with a specific MCS value to the user device. The AP may then receive a BA from the user device indicating that the packets have been received. The AP may record the statistics over a certain time. For example, for each selected MCS value, the AP may determine the proportion of packets that were successfully received, and based on that, the AP may select the next MCS value in the next subband. Another condition may be to perform SNR and quality indicator measurements per subband or MCS recommendations per subband that are fed back from the user device to the AP. This may facilitate a quick convergence toward the appropriate selection of MCS values per subband at the transmitting device.

In one example, the AP may determine if the BAs are sent per subband (e.g., whether a BA is sent on one subband). In that case, the statistics from the BA may relate to that subband and may be used for the link adaptation mechanism from that subband directly.

In another example, the AP may determine if a single BA is sent for all subbands. That is, the AP may filter the bitmap of the BA in order to regroup only the sequence numbers corresponding to MPDUs transmitted on the same subband and to use these sequence numbers for per subband link adaptation.

FIG. 6 shows a functional diagram of an exemplary communication station 600 in accordance with some embodiments. In one embodiment, FIG. 6 illustrates a functional block diagram of a communication station that may be suitable for use as an AP 102 (FIG. 1) or a user device 120 (FIG. 1) in accordance with some embodiments. The communication station 600 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 600 may include communications circuitry 602 and a transceiver 610 for transmitting and receiving signals to and from other communication stations using one or more antennas 601. The communications circuitry 602 may include circuitry that can operate the physical layer (PHY) communications and/or media access control (MAC) communications for controlling access to the wireless medium, and/or any other communications layers for transmitting and receiving signals. The communication station 600 may also include processing circuitry 606 and memory 608 arranged to perform the operations described herein. In some embodiments, the communications circuitry 602 and the processing circuitry 606 may be configured to perform operations detailed in FIGS. 1, 2, 3A-3B, 4A-4B, and 5A-5B.

In accordance with some embodiments, the communications circuitry 602 may be arranged to contend for a wireless medium and configure frames or packets for communicating over the wireless medium. The communications circuitry 602 may be arranged to transmit and receive signals. The communications circuitry 602 may also include circuitry for modulation/demodulation, upconversion/downconversion, filtering, amplification, etc. In some embodiments, the processing circuitry 606 of the communication station 600 may include one or more processors. In other embodiments, two or more antennas 601 may be coupled to the communications circuitry 602 arranged for sending and receiving signals. The memory 608 may store information for configuring the processing circuitry 606 to perform operations for configuring and transmitting message frames and performing the various operations described herein. The memory 608 may include any type of memory, including non-transitory memory, for storing information in a form readable by a machine (e.g., a computer). For example, the memory 608 may include a computer-readable storage device, read-only memory (ROM), random-access memory (RAM), magnetic disk storage media, optical storage media, flash-memory devices and other storage devices and media.

In some embodiments, the communication station 600 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 600 may include one or more antennas 601. The antennas 601 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 600 may include one or more of a keyboard, a display, a non-volatile memory port, multiple antennas, a graphics processor, an application processor, speakers, and other mobile device elements. The display may be an LCD screen including a touch screen.

Although the communication station 600 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 600 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 600 may include one or more processors and may be configured with instructions stored on a computer-readable storage device memory.

FIG. 7 illustrates a block diagram of an example of a machine 700 or system upon which any one or more of the techniques (e.g., methodologies) discussed herein may be performed. In other embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environments. The machine 700 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The machine 700 may further include a power management device 732, a graphics display device 710, an alphanumeric input device 712 (e.g., a keyboard), and a user interface (UI) navigation device 714 (e.g., a mouse). In an example, the graphics display device 710, the alphanumeric input device 712, and the UI navigation device 714 may be a touch screen display. The machine 700 may additionally include a storage device (i.e., drive unit) 716, a signal generation device 718 (e.g., a speaker), a subband MPDU aggregation device 719, a network interface device/transceiver 720 coupled to antenna(s) 730, and one or more sensors 728, such as a global positioning system (GPS) sensor, a compass, an accelerometer, or other sensor. The machine 700 may include an output controller 734, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)).

The storage device 716 may include a machine readable medium 722 on which is stored one or more sets of data structures or instructions 724 (e.g., software) embodying or utilized by any one or more of the techniques or functions described herein. The instructions 724 may also reside, completely or at least partially, within the main memory 704, within the static memory 706, or within the hardware processor 702 during execution thereof by the machine 700. In an example, one or any combination of the hardware processor 702, the main memory 704, the static memory 706, or the storage device 716 may constitute machine-readable media.

The subband MPDU aggregation device 719 may carry out or perform any of the operations and processes (e.g., the processes 500 and 550) described and shown above. For example, the subband MPDU aggregation device 719 may be configured to separate the frequency domain into one or more subbands, and may allocate one or more MPDUs that may be associated with each subband.

The subband MPDU aggregation device 719 may facilitate the transmission of the one or more MPDUs on a particular subband, such that the one or more MPDUs may go through a specific part of a physical layer (PHY) chain.

The subband MPDU aggregation device 719 may facilitate the modification of an MCS field in a header-A of PHY headers or preambles to indicate all of the subbands' MCSs. For example, an MCS field may indicate a specific subband. In another example, an average MCS value may be used and a differential MCS index adjustment per subband may be made in order to reduce the size of the fields. In another example, an index may be utilized to indicate a specific MCS value that is used for each subband. In yet another example, the header-B may be used by transmitting different header-Bs on each subband. In that case, the MCS indication should be transferred to header-B, and the MCS in header-B in a particular subband corresponds to that subband only.

The subband MPDU aggregation device 719 may enable link adaptation at a transmitting device. That is, the subband MPDU aggregation device 719 may adapt links between a transmitting device (e.g., an AP) and a receiving device (e.g., an STA) based on one or more conditions. For example, in one condition, the transmitting device may analyze the probability of reception of the MPDUs assigned to a particular subband, by looking at the block acknowledgments (BAs). That is, the transmitting device may determine whether the MPDUs assigned to a particular subband have been received by the receiving device based on looking at the BA received from a receiving device. This may allow the use of a simple link adaptation mechanism based only on link adaptation statistics. The link adaptation statistics may be based on the BA reception. For example, a transmitting device may send packets with a specific MCS value to the receiving device. The transmitting device may then receive a BA from the receiving device indicating that the packets have been received. The transmitting device may record the statistics over a certain time. For example, for each selected MCS value, the transmitting device may determine the proportion of packets that were successfully received, and based on that, the transmitting device may select the next MCS value in the next subband. Another condition may be to perform SNR and quality indicator measurements per subband or MCS recommendations per subband that are fed back from the receiving device to the transmitting device. This may facilitate a quick convergence toward the appropriate selection of MCS values per subband at the transmitting device.

The subband MPDU aggregation device 719 may determine if the BAs are sent per subband (e.g., whether a BA is sent on one subband). In that case, the statistics from the BA may relate to that subband and may be used for the link adaptation mechanism from that subband directly.

The subband MPDU aggregation device 719 may determine if a single BA is sent for all subbands. That is, the device that receives the BA may filter the bitmap of the BA in order to regroup only the sequence numbers (SNs) corresponding to MPDUs transmitted on the same subband and to use these sequence numbers for per subband link adaptation. The BA bitmap is used to indicate the received status of the MPDUs. Bit position n of the BA bitmap, if equal to 1, acknowledges receipt of an MPDU with an MPDU sequence control value equal to (SSC+n), where SSC is the value of the BA starting sequence control subfield. Bit position n of the BA bitmap, if equal to 0, indicates that an MPDU with an MPDU sequence control value equal to (SSC+n) has not been received.

It is understood that the above functions are only a subset of what the subband MPDU aggregation device 719 may be configured to perform and that other functions included throughout this disclosure may also be performed by the subband MPDU aggregation device 719.

While the machine-readable medium 722 is illustrated as a single medium, the term “machine-readable medium” may include a single medium or multiple media (e.g., a centralized or distributed database, and/or associated caches and servers) configured to store the one or more instructions 724.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 700 and that cause the machine 700 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD- ROM disks.

The instructions 724 may further be transmitted or received over a communications network 726 using a transmission medium via the network interface device/transceiver 720 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 720 may include one or more physical jacks (e.g., Ethernet, coaxial, or phone jacks) or one or more antennas to connect to the communications network 726. In an example, the network interface device/transceiver 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 700 and includes digital or analog communications signals or other intangible media to facilitate communication of such software. The operations and processes (e.g., processes 500 and 550) described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

According to example embodiments of the disclosure, there may be a device. The device may include at least one memory that stores computer-executable instructions. The device may further include at least one processor configured to access the at least one memory, wherein the at least one processor is configured to execute the computer-executable instructions to determine a first subband and a second subband of a frequency band associated with a communication channel established with a first device. The device may further include instructions to allocate a first media access control protocol data unit (MPDU) to the first subband. The device may further include instructions to allocate a second MPDU to the second subband. The device may further include instructions to cause the first MPDU to be wirelessly transmitted to the first device over the communication channel using a first modulation and coding scheme (MCS) value associated with the first subband. The device may further include instructions to cause the second MPDU to be wirelessly transmitted to the first device over the communication channel using a second MCS value associated with the second subband.

The implementations may include one or more of the following features. The first MPDU is transmitted using a first physical layer (PHY) chain, and the second MPDU is transmitted using a second PHY chain. The first MPDU may include at least in part a first header-A field and a first header-B field. The first header-A may include at least in part, an indication of the first MCS value. The first header-B may include an indication of the first MCS value. The at least one processor may be further configured to execute the computer-executable instructions to identify a block acknowledgment received from the first device. The at least one processor may be further configured to execute the computer-executable instructions to determine if the first MPDU is received by the first device based at least in part on the block acknowledgment. The device may further include instructions to cause to send the first MPDU using an average MCS value offset by a first adjustment associated with the first subband. The device may further include instructions to cause to send the second MPDU using the average MCS value offset by a second adjustment associated with the second subband. The device may further include instructions to encode a first header-B for transmission over the first subband. The device may further include instructions to encode a second header-B for transmission over the second subband, wherein the first header-B may include the first MCS, and wherein the second header-B may include the second MCS. The device may further include a transceiver configured to transmit and receive wireless signals. The device my further include one or more antennas coupled to the transceiver.

According to example embodiments of the disclosure, there may be a non-transitory computer-readable medium storing computer-executable instructions which, when executed by a processor, cause the processor to perform operations. The operations may include identifying a first MPDU received from a device on a first subband. The operations may include identifying a second MPDU received from the device on a second subband. The operations may include determining a block acknowledgment frame including at least in part an indication of the first MPDU or the second MPDU. The operations may include causing the block acknowledgment to be wirelessly transmitted to the device.

The first MPDU is transmitted using a first physical layer (PHY) chain of device, and the second MPDU is transmitted using a second PHY chain of the device. The first MPDU may include at least in part a first header-A field and a first header-B field. The first MPDU is associated with a first modulation and coding scheme (MCS) value and the second MPDU is associated with a second MCS value. The first MCS value is an average MCS value offset by a first adjustment associated with the first subband and the second MCS value is the average MCS value offset by a second adjustment associated with the second subband.

According to example embodiments of the disclosure, there may include a method. The method may include determining, by one or more processors, a first subband and a second subband of a frequency band associated with a communication channel established with a device. The method may include allocating a first media access control protocol data unit (MPDU) to the first subband. The method may include allocating a second MPDU to the second subband. The method may include causing the first MPDU to be wirelessly transmitted to the device over the communication channel using a first modulation and coding scheme (MCS) value associated with the first subband. The method may include causing the second MPDU to be wirelessly transmitted to the device over the communication channel using a second MCS value associated with the second subband.

The implementations may include one or more of the following features. The first MPDU is transmitted using a first physical layer (PHY) chain, and the second MPDU is transmitted using a second PHY chain. The first MPDU includes at least in part a first header-A field and a first header-B field. The first header-A includes at least in part, an indication of the first MCS value. The first header-B includes an indication of the first MCS value. The method may further include identifying a block acknowledgment received from the first device. The method may further include determining if the first MPDU is received by the first device based at least in part on the block acknowledgment. The method may further include sending the first MPDU using an average MCS value offset by a first adjustment associated with the first subband. The method may further include causing to send the second MPDU using the average MCS value offset by a second adjustment associated with the second subband. The method may further include encoding a first header-B for transmission over the first subband. The method may include encoding a second header-B for transmission over the second subband, wherein the first header-B includes the first MCS, and wherein the second header-B includes the second MCS.

In example embodiments of the disclosure, there may be an apparatus. The apparatus may include means for determining, by one or more processors, a first subband and a second subband of a frequency band associated with a communication channel established with a device. The apparatus may include means for allocating a first media access control protocol data unit (MPDU) to the first subband. The apparatus may include means for allocating a second MPDU to the second subband. The apparatus may include means for causing the first MPDU to be wirelessly transmitted to the device over the communication channel using a first modulation and coding scheme (MCS) value associated with the first subband. The apparatus may include means for causing the second MPDU to be wirelessly transmitted to the device over the communication channel using a second MCS value associated with the second subband.

The implementations may include one or more of the following features. The first MPDU is transmitted using a first physical layer (PHY) chain, and the second MPDU is transmitted using a second PHY chain. The first MPDU includes at least in part a first header-A field and a first header-B field. The first header-A includes at least in part, an indication of the first MCS value. The first header-B includes an indication of the first MCS value. The apparatus my further include means for identifying a block acknowledgment received from the first device. The apparatus my further include means for determining if the first MPDU is received by the first device based at least in part on the block acknowledgment. The apparatus my further include means for sending the first MPDU using an average MCS value offset by a first adjustment associated with the first subband. The apparatus my further include means for causing to send the second MPDU using the average MCS value offset by a second adjustment associated with the second subband. The apparatus my further include means for encoding a first header-B for transmission over the first subband. The apparatus my further include means for encoding a second header-B for transmission over the second subband, wherein the first header-B includes the first MCS, and wherein the second header-B includes the second MCS.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, comprising:
at least one memory that stores computer-executable instructions; and
at least one processor configured to access the at least one memory, wherein the at least one processor is configured to execute the computer-executable instructions to:
determine a first subband and a second subband of a frequency band associated with a communication channel established with a first device;
allocate a first media access control protocol data unit (MPDU) to the first subband;
allocate a second MPDU to the second subband;
cause the first MPDU to be wirelessly transmitted to the first device over the communication channel using a first modulation and coding scheme (MCS) value associated with the first subband; and
cause the second MPDU to be wirelessly transmitted to the first device over the communication channel using a second MCS value associated with the second subband.

2. The device of claim 1, wherein the first MPDU is transmitted using a first physical layer (PHY) chain, and the second MPDU is transmitted using a second PHY chain.

3. The device of claim 1, wherein the first MPDU includes at least in part a first header-A field and a first header-B field.

4. The device of claim 3, wherein the first header-A field includes at least in part, an indication of the first MCS value.

5. The device of claim 3, wherein the first header-B field includes an indication of the first MCS value.

6. The device of claim 1, wherein the at least one processor is further configured to execute the computer-executable instructions to identify a block acknowledgment received from the first device.

7. The device of claim 6, wherein the at least one processor is further configured to execute the computer-executable instructions to determine if the first MPDU is received by the first device based at least in part on the block acknowledgment.

8. The device of claim 3, wherein the at least one processor is further configured to execute the computer-executable instructions to:
cause to send the first MPDU using an average MCS value offset by a first adjustment associated with the first subband; and
cause to send the second MPDU using the average MCS value offset by a second adjustment associated with the second subband.

9. The device of claim 7, wherein the at least one processor is further configured to execute the computer-executable instructions to:
encode a first header-B field for transmission over the first subband; and
encode a second header-B field for transmission over the second subband, wherein the first header-B field includes the first MCS, and wherein the second header-B field includes the second MCS.

10. The device of claim 1, further comprising a transceiver configured to transmit and receive wireless signals.

11. The device of claim 10, further comprising one or more antennas coupled to the transceiver.

12. A non-transitory computer-readable medium storing computer-executable instructions which when executed by one or more processors result in performing operations comprising:
identifying a first MPDU received from a device on a first subband;
identifying a second MPDU received from the device on a second subband;
determining a block acknowledgment frame including at least in part an indication of the first MPDU or the second MPDU; and
causing the block acknowledgment to be wirelessly transmitted to the device.

13. The non-transitory computer-readable medium of claim 11, wherein the first MPDU is transmitted using a first physical layer (PHY) chain of the device, and the second MPDU is transmitted using a second PHY chain of the device.

14. The non-transitory computer-readable medium of claim 11, wherein the first MPDU includes at least in part a first header-A field and a first header-B field.

15. The non-transitory computer-readable medium of claim 11, wherein the first MPDU is associated with a first modulation and coding scheme (MCS) value and the second MPDU is associated with a second MCS value.

16. The non-transitory computer-readable medium of claim 14, wherein the first MCS value is an average MCS value offset by a first adjustment associated with the first subband and the second MCS value is the average MCS value offset by a second adjustment associated with the second subband.

17. A method comprising:
determining, by one or more processors, a first subband and a second subband of a frequency band associated with a communication channel established with a device;
allocating a first media access control protocol data unit (MPDU) to the first subband;
allocating a second MPDU to the second subband;
causing the first MPDU to be wirelessly transmitted to the device over the communication channel using a first modulation and coding scheme (MCS) value associated with the first subband; and
causing the second MPDU to be wirelessly transmitted to the device over the communication channel using a second MCS value associated with the second subband.

18. The method of claim 17, wherein the first MPDU is transmitted using a first physical layer (PHY) chain, and the second MPDU is transmitted using a second PHY chain.

19. The method of claim 17, wherein the first MPDU includes at least in part a first header-A field and a first header-B field.

20. The method of claim 19, wherein the first header-A field includes at least in part an indication of the first MCS value.
